(19) United States
(12) Patent Application Publication
(10) Pub. No.: US 2025/0153167 A1
(43) Pub. Date: May 15, 2025

(54) AEROSOL JET PRINTING TO FUNCTIONALIZE SUBSTRATES FOR PHYSIOLOGICAL SENSORS

(71) Applicant: CASE WESTERN RESERVE UNIVERSITY, Cleveland, OH (US)

(72) Inventors: Pedram Mohseni, Highland Heights, OH (US); Anirban Sen Gupta, Fairview Park, OH (US); Dante Disharoon, Cleveland Heights, OH (US); Changyong Cao, Okemos, MI (US); Michael Suster, Cleveland Heights, OH (US); Emily Song, Cleveland, OH (US)

(21) Appl. No.: 18/942,926

(22) Filed: Nov. 11, 2024

Related U.S. Application Data
(60) Provisional application No. 63/598,307, filed on Nov. 13, 2023.

(51) Int. Cl. B01L 3/00

(52) U.S. Cl. CPC B01L 3/502715; B01L 2200/10; B01L 2200/147; B01L 2300/0645; B01L 2300/1827; B01L 2400/0442

(57) ABSTRACT

As one example, methods and systems are provided for aerosol jet printing one or more bioactive agents on a substrate to functionalize the substrate. This disclosure also relates to the resulting functionalized substrates as well as to sensing devices and systems that include such functionalized substrates.

### RELATED APPLICATION

This application claims the benefit of priority to U.S. Provisional App. No. 63/598,307, filed Nov. 13, 2023, and entitled AEROSOL JET PRINTING TO FUNCTIONALIZE SUBSTRATES FOR PHYSIOLOGICAL SENSORS, which is incorporated herein by reference in its entirety.

### TECHNICAL FIELD

This description relates to aerosol jet printing to functionalize substrates, such as for physiological sensors.

### BACKGROUND

Bodily fluids contain rich information about a body's physical health. Alterations in the composition of bodily fluids can be a strong indicator of disease, injury, or nutrition. As a result, current medical practice relies heavily on bodily fluids such as blood, lymph, urine, sweat, saliva, mucus, cerebrospinal fluid, synovial fluid, pleural fluid, pericardial fluid, peritoneal fluid, semen, vaginal fluid, and amniotic fluid to diagnose and treat patients. Typically, a fluid will be collected and transported to a specialized laboratory, where it will be analyzed for function or composition using assays that quantify the concentration or activity of specific biochemical markers. This process acts as a bottleneck for the entire medical industry, as it typically takes 48-72 hours to receive results from bodily fluid tests. To eliminate this bottleneck, there have been significant efforts to develop point-of-care (POC) diagnostic tools that obviate central laboratory equipment and can generate results within minutes.

### BRIEF DESCRIPTION OF THE DRAWINGS

FIG. 1 is a schematic diagram of a system for aerosol jet printing a bioactive agent on a substrate.

FIGS. 2A through 2D show an example microscopy map of electrode structures having bioactive agents that were aerosol jet printed in different amounts.

FIG. 3 is a graph showing an amount of bioactive agent deposited on a substrate according to a percentage of surface area that was coated by the agent.

FIG. 4 is a graph showing normalized permittivity variations over time of a clotting blood sample for electrodes coated for different percentages of surface area by a bioactive agent.

FIGS. 5A and 5B depict microscopy images showing deposition of tissue factor-based ink on electrode surfaces.

FIG. 6 is a table showing examples of print parameters for tissue-factor inks.

FIG. 7 is a graph showing normalized permittivity variations over time of a clotting blood sample in different scenarios measured by respective sensors.

FIG. 8 is a bar chart showing Tₚₑₐₖ for different tissue factor concentrations.

FIG. 9 depicts examples of electrodes with different patterns of bioactive agents coated on the electrodes.

FIG. 10 is a bar chart showing Tₚₑₐₖ for different patterns of bioactive agents for the example electrodes of FIG. 9.

FIG. 11 depicts several examples of different patterns that can be used to control the amount and distribution of bioactive agents on substrates.

FIG. 12 depicts an example of an electrode patterned with multiple bioactive agents.

FIG. 13 depicts examples of different gradient patterns for bioactive agents that can be applied on one or more substrates.

FIG. 14 is a flow diagram showing an example method of aerosol jet printing a bioactive agent on a substrate.

FIG. 15 depicts an example of a sensing apparatus.

### DETAILED DESCRIPTION

This disclosure relates to methods and systems for aerosol jet printing (also referred to herein as AJP) one or more bioactive agents on substrates to functionalize the substrates. This disclosure also relates to the resulting functionalized substrates as well as to sensing devices and systems that include such functionalized substrates. For example, the approach described herein can be used to make physiological sensors or other devices configured to analyze properties of biological fluids responsive to such fluids interacting with the one or more bioactive agents that have been applied using aerosol jet printing. As used herein, a fluid can refer to any substance whose molecules can move freely past one another and has a tendency to assume the shape of its container, such as having a liquid and/or gas.

As an example, a portion of a sensing device that is adapted to be contacted by a biological fluid sample under test includes an arrangement of electrodes (e.g., microelectrodes). One or more of the electrodes and/or another portion of the device, which will contact the fluid sample under test before or during testing, can be functionalized by aerosol jet printing one or more bioactive agents on such substrates. As described herein, aerosol jet printing thus provides a versatile approach for patterning a wide range of bioactive agents and/or other biological materials on various substrates. The materials that are aerosol jet printed can vary depending on the type of sample under test and the type of analysis to be performed on the sample.

As a further example, a point-of-care sensing apparatus is configured to perform impedance-based spectroscopy of a sample under test (SUT), such as a biological fluid (e.g., blood, lymph, urine, sweat, saliva, mucus, cerebrospinal fluid, synovial fluid, pleural fluid, pericardial fluid, peritoneal fluid, semen, vaginal fluid, and amniotic fluid). For example, the fluid under test is placed in a chamber (e.g., a microfluidic chamber or channel), in which the fluid contacts and interacts with the one or more bioactive agents that have been applied using aerosol jet printing, such as described herein. As a further example, the sensing apparatus is configured to implement dielectric coagulometry (DC), in which the sensing apparatus is configured to measure dielectric permittivity variations over time of a blood SUT responsive to the blood SUT interacting with the bioactive agent. For instance, when the blood SUT begins to clot, the measured permittivity peaks, and the sensing apparatus can be configured to quantify clotting parameters. Irregularities in clotting parameters can be caused by both chronic (i.e., hemophilia, von Willebrand disease, thrombocytopenia) and acute (trauma-induced coagulopathy) disorders, which impact the function of the active components of hemostasis: platelets, coagulation factors, or the fibrinolytic system. The sensing apparatus thus can provide a readout parameter based on the determined dielectric permittivity values, such as for a quantitative assessment of hemostatic dysfunction and/or associated coagulopathy, a measure of platelet function, or other properties. Additionally, by using aerosol jet printing to functionalize the electrodes or other substrates of sensing apparatus, as described herein, DC can be implemented to detect bleeding disorders, as well as further diagnose the underlying cause and/or determine which treatments should be administered. Examples of some sensing apparatuses having surfaces (e.g., electrodes and/or other surfaces exposed to a sample under test) that can be functionalized by using aerosol jet printing for coating such surface(s) with one or more bioactive reagents are described in U.S. Pat. Pub. No. 2022/0326170, which is incorporated herein by reference. The approaches described herein to coat sensor surfaces with bioactive agents also can be utilized in other types and configurations of sensing apparatuses. The surfaces of each such sensing apparatus thus can be functionalized with one or more bioactive agents to facilitate sensing, such as dielectric spectroscopy and, in particular, DC.

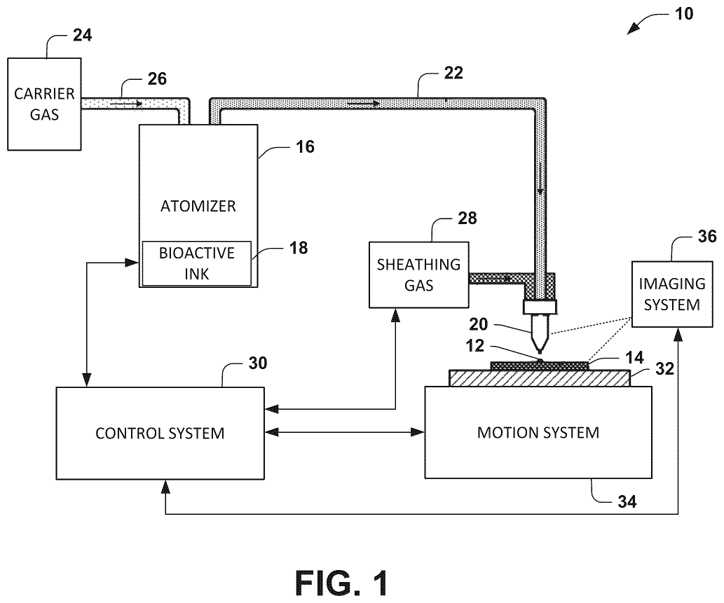

FIG. 1 is a block diagram of a system 10 configured to perform aerosol jet printing of a bioactive agent 12 on a substrate 14. The system includes an atomizer 16, such as a pneumatic atomizer, configured to aerosolize bioactive ink 18, which can reside in a reservoir (e.g., a container or vial) within the atomizer. There can be one or more bioactive agents in the ink 18, and there can be more than one reservoir containing one or more bioactive inks within the atomizer. In some examples, different bioactive inks can be swapped out for one another, such as by removing and replacing one bioactive ink containing one or more first agents with another bioactive ink containing one or more different agents.

Examples of some procoagulant bioactive agents that may be utilized to provide the bioactive ink 18, individually or in combination, include collagen, fibrinogen, collagen-mimicking peptide (CMP), cross-linked collagen-related peptide (CRP-XL), convulxin, tranexamic acid (TXA), inorganic polyphosphate (PolyP), chitosan, kaolin, phosphatidylserine (PS), Adenosine 5′-diphosphate (ADP), thrombin, thrombin receptor-activating peptide (TRAP, such as TRAP-6), aprotinin, Tissue Factor (TF) and the like. TF is an agonist for the extrinsic coagulation pathway, which accelerates clotting and decreases the kinetic Tₚₑₐₖ parameter when used in DC assays in either the soluble phase or when coated onto electrodes, such as by using AJP described herein.

The atomizer 16 is further configured to supply an aerosol gas stream from the atomizer to a deposition head 20, such as through a length of a conduit 22. The conduit 22 fluidly connects an outlet of the atomizer 16 with an inlet of the deposition head 20. The atomizer 16 also includes an inlet coupled to a source of carrier gas (e.g., nitrogen (N₂) or other inert gas), shown at 24. Another conduit 26 can connect the source of carrier gas 24 with an inlet of the atomizer 16. In some examples, the atomizer 16 is configured so the aerosol flow inlet is positioned opposite the aerosol flow outlet. The atomizer can also include a mass flow controller configured to control exhaust flow of excess carrier gas from the atomizer 16, such as at an angle that is approximately 90 degrees from the aerosol inlet/outlet line of travel, which can aid in the control of the mass flux of the bioactive ink material that passes to the deposition head 20. Various configurations of atomizers and related equipment (e.g., impactor or virtual impactor, flow control, etc.) can be used to generate and supply the aerosol stream having a desired droplet size and desired concentration of bioactive agent according to aerosolization of the bioactive ink 18. A source of sheathing gas 28 can also supply sheathing gas to the deposition head 20, which can be supplied coaxially (along a central axis of the deposition head 20) with the aerosol stream through the conduit 22.

In an example, a control system 30 is configured to control and coordinate process parameters for various parts of the system 10. The control system 30 can control the atomizer, such as by controlling the exhaust flow of the carrier gas that is supplied to the atomizer 16. The control system 30 can also control the aerosolization process, such as by controlling temperature, frequency or other process parameters of an impactor employed by the atomizer 16. The control system 30 further can control the sheathing gas that is supplied to the deposition head 20. The deposition head 20 thus can form an annular, coaxial flow between the aerosol stream (e.g., in conduit 22) and the sheathing gas stream. The coaxial flow exits the print head through a nozzle directed at a surface of the substrate 14. For example, the deposition head 20 of the aerosol jet printing system 10 is configured to use aerodynamic focusing for high-resolution deposition of the aerosol stream (e.g., with droplets of 1˜5 μm in diameter containing a precise amount and concentration of bioactive agent), in which the bioactive ink is focused through the deposition head 20 onto the substrate 14. The aerosol jet printing system 10 can deposit features with sizes down to 10 μm (or smaller) with high repeatability, good edge definition, good conductivity due to high metal loading, single-pass thickness (e.g., from 10 nm to 5 μm), low surface roughness, and good adhesion onto the substrate 14. The substrate 14 can be implemented as a variety of materials (e.g., glass, metal, polyimide, PET, etc.). In one example, the substrate is a metal electrode, such as formed of a gold material, and the bioactive ink can be deposited selectively on a portion or over all of a respective surface of the electrode to form an agent-coated surface region (e.g., a layer) containing a concentration of one or more bioactive agents. The aerosol jet printing system 10 thus can deposit various aerosolized bioactive inks with a large difference in viscosity, which can vary the resulting thickness of the resulting layer according to application requirements and the substrates onto which it is being applied. The system can be controlled (e.g., by the control system 30) to apply a number of one or more layers of the same or different bioactive agents on the substrate 14 to provide a desired thickness and quantity of respective bioactive agent material(s).

As a further example, the substrate 14 is attached to and/or supported by a platen 32. A motion system 34 is configured to move the platen in two-dimensional or three-dimensional space for patterning the bioactive ink from the deposition head 20 onto the substrate 14. For example, the control system 30 can control the motion system 34 to move the platen during the deposition process for patterning the bioactive ink on the substrate 14. To help control the deposition process, the system 10 can include an imaging system 36, such as including one or more cameras (e.g., two digital cameras) as well as one or more other sensors to provide data representative of one or more deposition, position, and/or other process parameters. For example, the imaging system 36 acquires images (e.g., real time images acquired at a sample rate) of the substrate and deposition head 20, such as including one or more alignment markers on the substrate and the current printed layer being applied. The control system 30 can be programmed to make fine adjustments to the position and/or rotation before each printing pass based on the acquired images to ensure proper alignment between layers applied to the substrate.

The control system 30 can implement a broad range of controllable aerosol jet printing variables compared to other printing modalities (e.g., inkjet, screen, and gravure printing) due to the wide parameter space from atomization to relevant gas flows, nozzle size, and print speed. The control system 30 can be configured to control these and other process parameters, such as in response to user input instructions entered through a user input device.

The system 10 of FIG. 1 can be used to perform a method of applying a bioactive agent on a substrate 14, such as one or more electrodes or one or more other surfaces of the fluidic chamber adapted to hold a volume of a fluid SUT. The fluid SUT can be a biological fluid, such as blood or another fluid, as described herein. The method includes providing a bioactive ink (e.g., ink 18) having a concentration of one or more bioactive agents, which are adapted to interact with the biological fluid. The bioactive ink is atomized (e.g., by atomizer 16) to provide an aerosol stream containing droplets of a respective known size of the bioactive ink 18.

In one example, the bioactive ink 18 includes a concentration of thrombin receptor-activating peptide 6 (TRAP-6) adapted to promote TRAP-6 interaction with gold electrodes. For example, TRAP-6 is modified via C-terminal cysteine addition in order to introduce a thiol group to the peptide. Cysteinylated TRAP-6 can be reconstituted to 2 mg/mL in 10-μM aqueous NaOH solution (pH=9.0). At this basic pH, the thiol attached to TRAP-6 deprotonates and forms a covalent bond with the gold electrode surface. This biochemical interaction between such ink and a metal (e.g., gold) substrate is facilitated.

The TRAP-6 ink is unique for several reasons. First, it has low viscosity (μ=1 cP) and specific gravity (SG=1). Aerosol jet printing inks typically have viscosities ranging from 10 to 1,000 cP and contain dense materials that can increase the specific gravity two- to three-fold. Second, the TRAP-6 ink has a high surface tension of ˜73 mN/m, whereas most aerosol jet printing inks incorporate surfactants, which reduce their surface tension to 20-40 mN/m. Third, the TRAP-6 ink further contains a moderate concentration of a small peptide, whereas traditional inks contain a high density of particulates, such as with diameters as high as 200 nm. These differences between the TRAP-6 ink described herein and other inks are, at least in part, due to the particular intended functionalization and sensing application for which it is to be used. For instance, aerosol jet printing is traditionally used to deposit films of solid materials such as metals, conductors, resistors, semiconductors, photopolymers, thermosetting polymers, or thick organics. For these materials, a high ink viscosity is desirable because the viscosity is proportional to the amount of solid material contained within the solvent phase. However, highly viscous fluids are difficult to aerosolize, so the addition of surfactants becomes necessary to reduce surface tension and facilitate aerosolization of monodisperse droplets. Because the TRAP-6 ink described herein is not predicated on solid particulates, its viscosity remains low, and it is easily aerosolized.

To further improve the bioactive ink for aerosol jet printing, in some examples, TRAP-6 can be reconstituted in 50% (in weight) glycerol, which would increase its viscosity to 10 cP. Then, albumin or a surfactant could be added to the solution to reduce surface tension and control aerosolized droplet diameters. The resulting ink is expected to enable more precise control over printed features, while retaining the unique characteristic of depositing a bioactive reagent material with substrate-specific interaction. Moreover, these approaches could be generalized to any aqueous ink, including those loaded with small molecules, peptides, polypeptides, enzymes, lipids, acids, bases, cellular components, etc.

A volume of the bioactive ink is aerosol jet printed on a surface (or surfaces) of the substrate 14 while supported on a platen 32, which is moved relative to deposition head 20 during printing on the substrate. The substrate 14 can be an electrode of a sensor (e.g., a capacitive sensing structure) or another interior wall of a fluidic (e.g., microfluidic) chamber that is adapted to hold a volume of the fluid SUT. After the layer (or layers) of one or more bioactive agents are applied on the substrate, the substrates can be assembled to form the fluidic chamber. Thus, the chamber includes an interior volume, and the agent-coated substrate is arranged so the bioactive ink is exposed within the chamber. Examples of some types and configurations of microfluidic chambers are disclosed in the above incorporated U.S. Pat. Pub. No. 2022/0326170, and the bioactive agents can be applied to functionalize one or more surfaces of the chamber using aerosol jet printing, as described herein. That is any surface of the chamber can constitute the substrate onto which the bioactive ink is printed. For example, the substrate includes at least one plate of a multi-plate capacitive sensing structure and the aerosol jet printing system 10 is used to apply one or more layers of bioactive agents on a surface portion of the plate such that the interior surface of the chamber is functionalized to interact with the biological fluid SUT within the microfluidic chamber. The resulting sensing apparatus can be configured to perform various testing functions by functionalizing the test chamber with one or more aerosol-jet printed bioactive agents, such as described herein.

The thickness and concentration of the one or more bioactive agents that are aerosol-jet printed on a selected area of the substrate 14 can be controlled to a high degree of precision by controlling one or more process parameters of the aerosol jet printing system 10. While much of this description describes aerosol jet printing a bioactive ink onto a substrate, in some examples, the system 10 can also be used to form substrate (or a portion thereof) onto which bioactive ink is subsequently printed. For example, an electrically conductive ink solution can be used in place of the bioactive ink 18 (e.g., a metal ink, such as gold) and an electrode structure of the electrically conductive material can be aerosol jet printed on a sacrificial substrate or directly on the platen 32. After the electrode structure is formed, one or more layers of the bioactive ink can be aerosol jet printed on the surface of the electrode structure, as described herein. The resultant coating of the bioactive agent can have a thickness that is about 5 μm or greater (e.g., 10 μm or greater). Additionally, aerosol-jet-printed coating can contain patterns of more than one different bioactive agent, which can be applied from the same ink or using separate bioactive ink solutions patterned on the substrate in different printed layers. The different layers can overlap one another partially or wholly or the layers can be spatially separated from each other along different areas of the substrate.

### Example Use Case for Aerosol Jet Printing

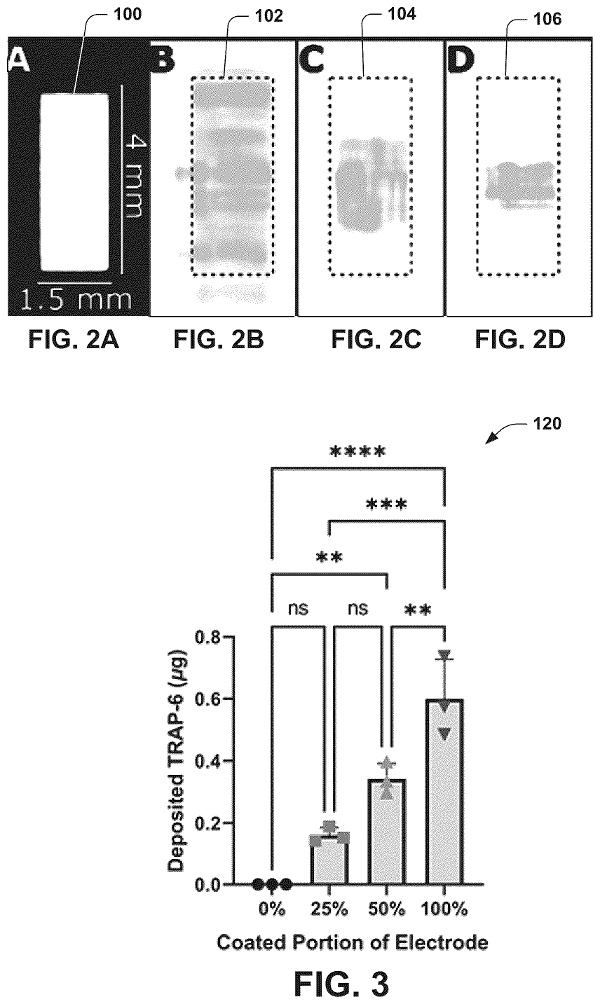

FIGS. 2A through 2D show an example microscopy map of electrode structures 100, 102, 104, and 106 having bioactive agents that were aerosol jet printed on the electrode structures in different amounts. The respective colors in the maps have been inverted to help visualize the microscopy images. For example, rectangular gold electrodes were used having fixed dimensions (1.5 mm×4 mm). FIG. 2A shows an electrode structure 100 that includes no bioactive agent and the respective electrode structures 102, 104, and 106 of FIGS. 2B through 2D include different amounts of coating on the same size and configuration of rectangular electrode structure. Specifically, the bioactive agent is patterned to coat 100% of the surface in FIG. 2B, 50% of the surface in FIG. 2C, and 25% of the surface in FIG. 2D. In the example of FIGS. 2A-2D, the surface area has been aerosol jet printed to deposit thrombin receptor-activating peptide 6 (TRAP-6)—a bioactive reagent that accelerates clotting kinetics by activating platelets—onto gold electrodes. For example, a colorimetric activity assay was used to quantify the total amount of TRAP-6 deposited onto each electrode. Uncoated electrodes (0% TRAP-6 surface coverage), as shown in FIG. 2A, were used as a negative control.

FIG. 3 is a graph 120 showing an amount of bioactive agent deposited on a substrate according to a percentage of surface area that was coated by the agent. As shown in the graph 120 of FIG. 3, the amount of deposited TRAP-6 increased linearly with the coated surface area. To determine whether TRAP-6-coated electrodes could affect blood clotting kinetics, we used the electrodes in DC clotting assays. For these, the permittivity of clotting blood was measured over time, and the timestamp for the permittivity peak was parameterized as the clotting time.

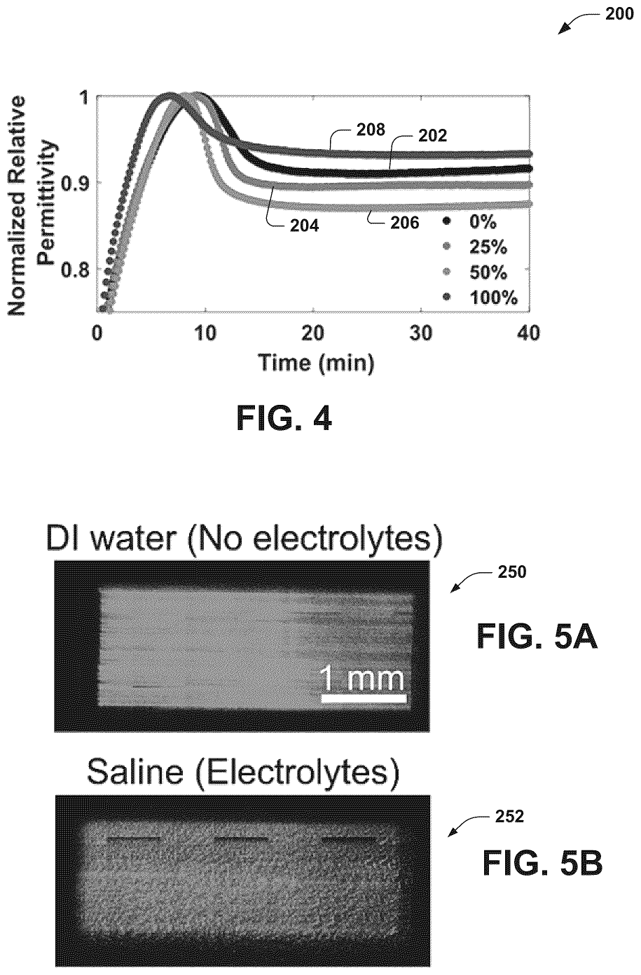

FIG. 4 is a graph 200 showing normalized permittivity variations over time of a clotting blood sample for electrodes with different amounts of bioactive agent coatings (e.g., TRAP-6). The graph includes plots 202, 204, 206, and 208 for electrodes having 0%, 25%, 50% and 100%, respectively, of their surface area coated with TRAP-6. In FIG. 4, the timestamp for the peak is parameterized as clotting time. Clotting time decreases with increasing surface coverage of TRAP-6 as expected. Blood on uncoated electrodes clotted in 9.7 min (shown in plot 202), and the clotting time decreased with increasing TRAP-6 coverage. Electrodes fully coated with TRAP-6 (e.g., shown by plot 208) accelerated clotting kinetics the most, reducing the clotting time to approximately 6.7 min. These data indicate that aerosol jet printing can be used to finely tune the bioactivity of agent-coated materials, which is advantageous when working with biological fluids where many agents can be ineffective at low concentrations but toxic at high concentrations.

In view of the examples of FIGS. 1-4, it is shown that aerosol jet printing can be used to coat electrodes with an ink that induces rapid platelet activation and subsequent blood clotting; however, the versatility of this technique enables the fabrication of a wide range of bioactive-functionalized electrodes for biosensing and other types of fluid analysis. For example, inks containing tissue factor or kaolin could be deposited to generate surface-engineered electrodes that probe coagulation factor-specific function in blood. Aprotinin or tranexamic acid could be used to assess the state of the fibrinolytic system. These materials all have distinct characteristics; TRAP-6 is a small peptide, tissue factor is a liposome-anchored protein, kaolin is a mineral derived from clay, aprotinin is a polypeptide, and tranexamic acid is a small molecule. Advantageously, aerosol jet printing provides a simple and elegant approach that can be used for depositing each of these materials, as well as other materials, including other small peptides, lipidated proteins, as well as other materials, with precise control over the amount and distribution of each deposited reagent. As described herein, aerosol jet printing can be used to coat a single electrode (or other surface) with prescribed patterns of two or more different reagents to create single sensors with multiple biological effects. For example, dielectric spectroscopy (e.g., using the sensing apparatus in the above-incorporated patent) with bioactive-functionalized electrodes could be used to characterize a wide range of biological fluids, particularly those rich in cellular components (e.g., lymph, semen, cerebrospinal fluid, etc.).

As also described herein, AJP can be implemented for coating electrodes (or other surfaces) with bioactive reagents for dielectric coagulometry (DC). For example, an ink can contain liposomes embedded with the transmembrane protein tissue factor (TF), namely, lyophilized TF. Lyophilized TF can be reconstituted in the presence or absence of electrolytes for application through AJP as described herein. For example, it has been determined that inks devoid of electrolytes (e.g., TF reconstituted in deionized (DI) water) aerosolized more readily and resulted in more stable deposition in AJP. Nonetheless, it has been determined that robust deposition of TF ink on electrode surfaces can be achieved in both the presence and absence of electrolytes.

FIGS. 5A and 5B depict microscopy images 250 and 252 showing deposition of tissue factor-based ink on electrode surfaces. For example, the ink is a TF ink containing the fluorophore rhodamine B (RhB). The microscopy images 250 and 252 of FIGS. 5A and 5B demonstrate suitable delivery of TF onto gold electrodes. By characterizing deposition uniformity, underspray, overspray, and satellite generation, print parameters for applying TF inks can be optimized, both without electrolytes (shown in image 250 of FIG. 5A) and with electrolytes (shown in image 252 of FIG. 5B).

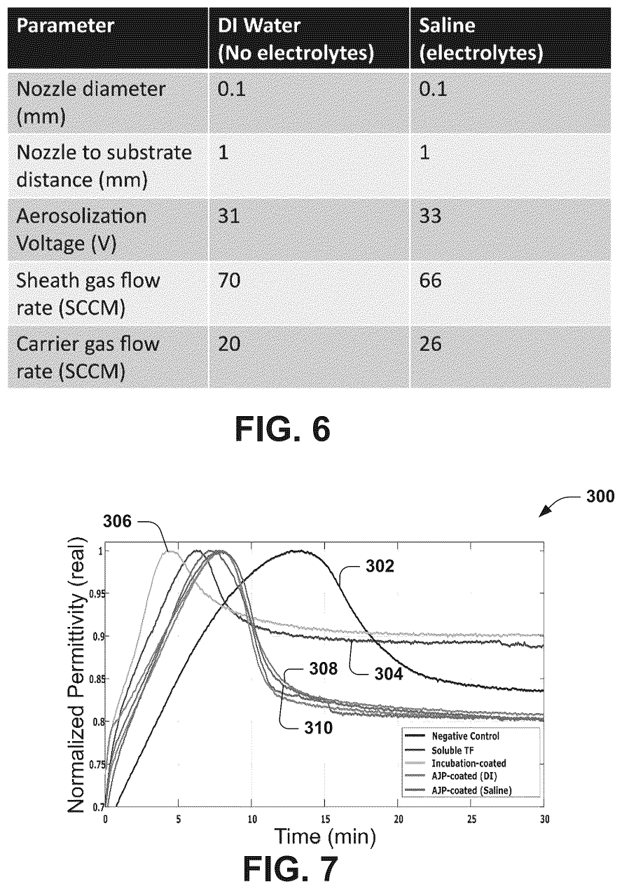

FIG. 6 is a table showing examples of some AJP print parameters for tissue-factor inks that are reconstituted in DI water (without electrolytes) and saline (with electrolytes). The deposited ink had potent activity in DC assays. TF is an agonist for the extrinsic coagulation pathway, which accelerates clotting and decreases the kinetic Tₚₑₐₖ parameter when used in DC assays in either the soluble phase or when coated onto electrodes, such as described herein.

FIG. 7 is another graph 300 that includes plots 302, 304, 306, 308, and 310 showing normalized permittivity variations over time of clotting blood samples in different scenarios measured by respective sensors. The plot 302 shows normalized permittivity for a blood sample in a sensor having an uncoated electrode without TF, which provides a negative control. The plot 304 shows normalized permittivity for a blood sample having soluble TF (e.g., TF added manually to the blood sample), which provides a positive control. The plot 306 shows normalized permittivity for a blood sample exposed to an incubation-based TF-coated electrode, which provides another positive control. The plot 308 shows normalized permittivity of a blood sample exposed to an electrode that has been coated with a TF ink using AJP. For example, an AJP system (e.g., system 10) is configured for lyophilized TF reconstituted in DI water to provide TF ink devoid of electrolytes, and the electrolyte-free TF ink is aerosol-jet printed on the electrode. The plot 310 shows normalized permittivity of a blood sample exposed to an electrode that has been coated with another TF ink using AJP. For example, an AJP system (e.g., system 10) is configured for lyophilized TF reconstituted in saline to provide TF ink that includes electrolytes, and the TF ink is aerosol-jet printed on the electrode. Plots 308 and 310 demonstrate representative DC profiles for sensors assembled using electrodes coated with the TF inks (e.g., 16 μg/mL TF ink concentration) using optimized AJP print parameters, such as the parameters described in FIG. 6. FIG. 7 also demonstrates that the sensor electrode coated with TF (e.g., using the electrolyte-free TF ink, as represented in plot 308) exhibited a significant reduction in the clotting kinetic parameter Tₚₑₐₖ in DC assays compared to uncoated sensors (e.g., a negative control, represented in plot 302). The plot 304 of normalized permittivity for the blood sample that includes soluble TF and the plot 306 for the blood sample exposed to the incubation-based TF-coated electrode, used as positive controls, exhibit a slightly greater effect on clotting time (e.g., reducing Tₚₑₐₖ to approximately 5 minutes or less than 5 minutes).

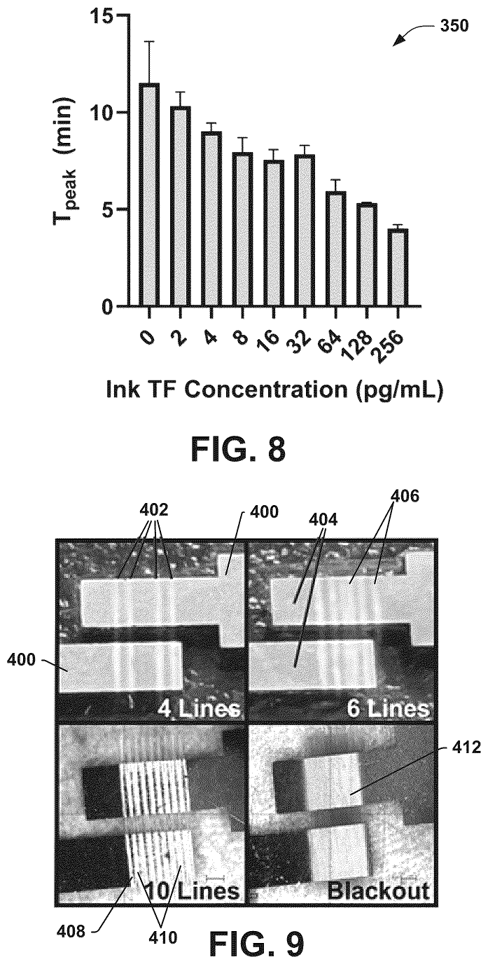

FIG. 8 is a bar chart 350 showing Tₚₑₐₖ for different tissue factor (TF) ink concentrations. The bar chart 350 demonstrates that the effect of AJP-coated sensors on Tₚₑₐₖ depends on the concentration of TF in the ink that is coated on the electrodes. Therefore, AJP enables control of the functional activity of DC electrodes by tuning the concentration of the bioactive agent in the ink. This can be useful because some reagents like TF are highly potent, and it is often necessary to target specific concentrations to control dose to enable accurate sensing for DC.

In addition, or as an alternative, to controlling concentration of bioactive agents, the systems (e.g., the system 10) and methods (e.g., method 600) described herein can configure parameters of the AJP to further control dose through spatial control of the geometry of printed ink containing one or more bioactive agents. This approach is unique and impactful because it can enable dose titration without ink modification, obviating the need to re-optimize print parameters to deposit different inks. FIG. 9 depicts images of multiple example electrodes with different spatial patterns of bioactive agents AJP-coated on the electrodes. In the example of FIG. 9, AJP was configured to spatially control printing TF onto the surfaces of respective electrodes. Specifically, electrodes 400 include four lines 402 extending across the electrode surface in a direction transverse to a longitudinal direction of the respective electrodes. Electrodes 404 include six lines 406 extending across the electrode surface in a direction transverse to a longitudinal direction of the respective electrodes. Electrode 408 includes ten lines 410 extending across the electrode surface in a direction transverse to a longitudinal direction of the electrode. Electrode 412 shows a fully coated electrode (referred to as a blackout electrode). Compared to uncoated electrodes, which showed a Tₚₑₐₖ of approximately 10 minutes in healthy blood, blackout electrodes reduced the Tₚₑₐₖ to less than 3 minutes, because they substantially activate extrinsic coagulation pathway.

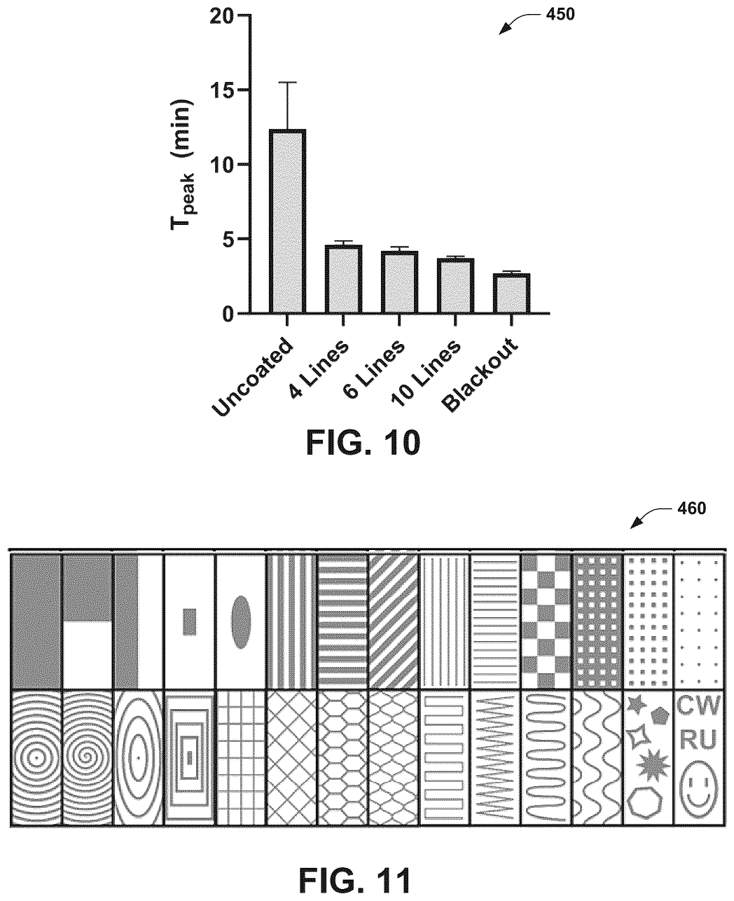

FIG. 10 is a bar chart 450 showing Tₚₑₐₖ for different example electrodes of FIG. 9 (e.g., coated with TF ink) as well as an uncoated electrode. As shown in FIG. 10, electrodes with fewer lines (i.e., a smaller surface area of TF ink film) resulted in a lesser shift in Tₚₑₐₖ in a dose-dependent manner. These data demonstrate that AJP enables precise concentration control for aerosol-jet-printed bioactive agents. While the example of FIGS. 9 and 10 used spatially interspersed linear geometry, the systems (e.g., system 10) and methods (e.g., method 600) described herein are substantially unlimited in the pattern geometries that can be applied via AJP to precisely control concentration of bioactive agents printed on substrates.

By way of example, FIG. 11 depicts a chart 460 showing some examples of different patterns that can be formed on the surface of a substrate (e.g., electrode) using AJP systems (e.g., system 10) and methods (e.g., method 600) described herein to control the spatial distribution of bioactive agents on substrates. As shown in FIG. 11, examples of possible patterns 460 include simple geometries, lines, checkerboards, grids, spirals, concentric shapes, cross-hatches, honeycombs, zig-zags, arbitrary shapes containing straight or curved lines, and even text. Other patterns (e.g., logos, bar codes, images, and the like) can be formed on the substrate surfaces in other examples. Moreover, in some examples, more than one pattern can be AJP-printed on the surface of a given substrate, each of which patterns can include the same or different bioactive agents.

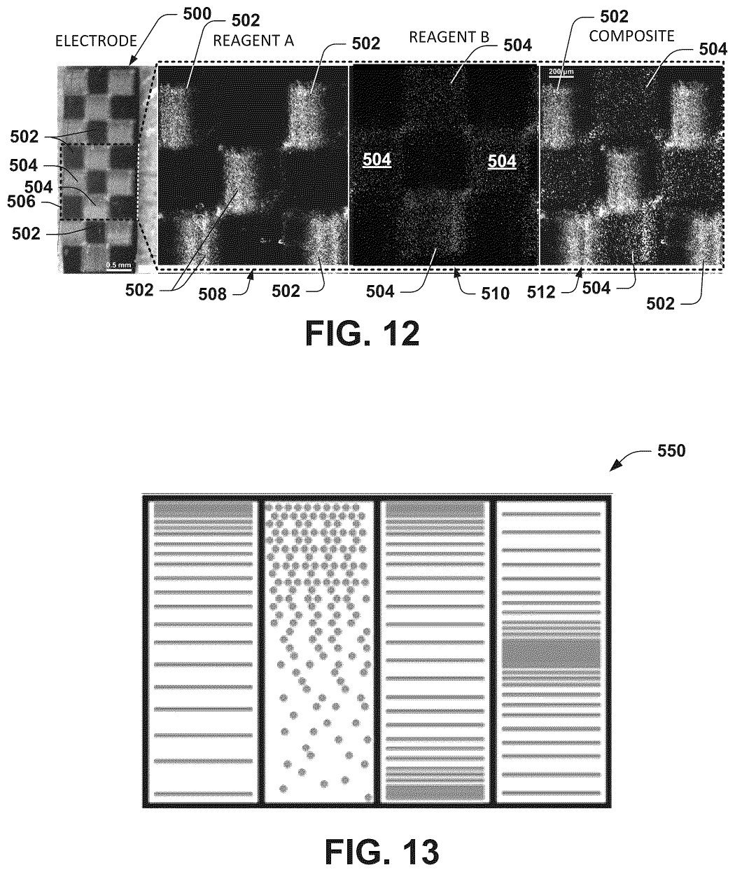

Precise spatial control of ink deposition offers several advantages in addition to dose control. As an example, precise spatial control of bioactive ink (e.g., using AJP as described herein) enables coating multiple (e.g., two or more) bioactive inks onto a single substrate (e.g., electrode). FIG. 12 depicts an example of an electrode 500 patterned with multiple bioactive agents, shown at 502 and 504. In an example, the electrode 500 can be the floating electrode of a sensor apparatus (e.g., sensor 702) as described in the above-incorporated U.S. Pat. Pub. No. 2022/0326170. In the example of FIG. 12, a checkerboard pattern is formed on the surface of the electrode 500 (e.g., using systems and methods described herein), in which alternating squares on the checkerboard are coated with one of two different reagents 502 and 504. A region 506 of the functionalized electrode surface that includes the patterned reagents 502 and 504 is shown in enlarged views 508, 510, and 512 to the right of the electrode 500. The enlarged views 508 and 510 illustrate each of the bioactive agents individually (shown as REAGENT A and REAGENT B) and the enlarged view 512 illustrates the reagents combined (shown as COMPOSITE) for the region 506. In principle, the total and relative quantity of each reagent could be controlled by manipulating the surface area of each reagent. A significant advantage of this approach in the context of DC is that this approach can be used to deposit incompatible reagents onto different spatial regions of the same electrode, such as in the checkerboard pattern of FIG. 12. Two or more different bioactive agents thus can be applied onto surfaces of substrates in a checkerboard or other pattern (e.g., using systems and methods described herein) to functionalize the substrates for a variety of sensing purposes, such as described herein.

As an example, negatively charged polyphosphates or kaolin derivatives can be used to probe intrinsic pathway-specific coagulation function. For coagulation to occur, calcium ions need to be present in the system, because they are a cofactor for thrombin generation. However, polyphosphates and kaolin are both negatively charged and will readily bind to the positively charged calcium. This can deactivate polyphosphates or kaolin, deplete calcium, or both; in any case, measured coagulation function would be artificially reduced. Therefore, using AJP to deposit a recalcification buffer and polyphosphates or kaolin in spatially discrete regions on electrode surfaces provides an efficacious and elegant solution, preventing the reagents from interacting until they are solvated by a blood or other fluid sample under test.

Another unique feature of spatially distributing reagents is the ability to establish concentration gradients. For example, a higher pattern density could be printed on one end of an electrode than the other end of the electrode. The pattern density can be controlled across the surface area in different amounts according to application requirements. FIG. 13 depicts another chart 550 showing examples of some gradient patterns for bioactive agents that can be formed on substrates via AJP according to the systems (e.g., system 10) and methods (e.g., method 600) described herein. In DC, AJP-printed gradient patterns would be useful for controlling concentration throughout a sensor. Though DC is performed in static conditions, blood is injected into the sensor at the beginning of each assay. The flow profile during this injection likely causes a higher concentration of reagent to localize towards the outlet of the sensors. Compensating for this by using AJP to bias deposition density towards the inlet of the sensor by a gradient pattern of the bioactive agent can help achieve a more uniform concentration gradient of bioactive agents in DC or other assays.

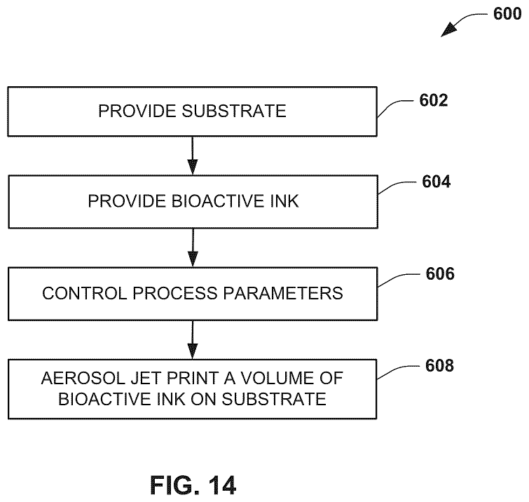

In view of the foregoing structural and functional features described above, example methods that can be implemented will be better appreciated with reference to the flow diagram of FIG. 14. While, for purposes of simplicity of explanation, the method 600 of FIG. 14 is shown and described as executing serially, it is to be understood and appreciated that the method is not limited by the illustrated order, as some aspects could, in other examples, occur in different orders and/or concurrently. Moreover, not all illustrated features may be required to implement a method. The method 600 can be implemented by the system 10 of FIG. 1 and as further described with respect to the examples of FIGS. 2-13 and 15. Accordingly, the method 600 may refer to certain aspects of FIGS. 1-13 and 15.

At 602, the method 600 includes providing a substrate (e.g., substrate 14 of FIG. 1) having one or more surfaces to be functionalized. As an example, the substrate can include one or more electrode structures that are formed or otherwise provided at 602 as part of the method 600. The electrode structure thus can be formed of an electrically conductive material that defines the substrate having one or more surfaces on which a bioactive ink is to be applied.

At 604, the method 600 includes providing a bioactive ink having a concentration of a bioactive agent adapted to interact with a biological fluid. For example, the bioactive agent in the bioactive ink includes a concentration of thrombin receptor-activating peptide 6 (TRAP-6). In another example, the bioactive agent in the bioactive ink includes a concentration of tissue factor (TF). Other bioactive agents can be implemented in respective bioactive inks in other examples.

At 606, the method 600 includes controlling one or more process parameters for the AJP to be performed. As described herein, the process parameters can be set (e.g., to default or programmable values through a user interface responsive to user inputs) to control the concentration and/or spatial distribution of a volume of bioactive ink that is deposited on the surface of the substrate. In some examples, the process parameters are configured to print two or more bioactive inks on a surface of the substrate, in which each of the two or more bioactive inks includes a different bioactive agent. The respective inks can be applied with or without overlapping on the surface area of the substrate. Also, or as an alternative, at least one process parameter can be configured at 606 to control a printed geometry for the bioactive ink on the substrate to control a dose of bioactive agent. In examples when two or more bioactive inks are printed on the substrate surface, process parameters of the AJP apparatus can be configured to control a printed geometry for each of the bioactive inks to provide respective patterns on the substrate surface, including the different bioactive agents, to provide a single sensor with multiple biological effects as described herein.

At 608, the method 600 includes aerosol jet printing a volume of the bioactive ink on a substrate. As described herein, the substrate can be an electrode of a sensing apparatus. In some examples, the substrate includes at least one plate of a multi-plate capacitive sensing structure (see, e.g., sensing structures in the above-incorporated U.S. Pat. Pub. No. 2022/0326170). The method 600 can further include forming a sensing structure that includes the electrode, which can be used to form a sensing system (e.g., sensor 702 of sensing system 700). The sensing structure can be within and/or form part of a chamber, such as a microfluidic chamber configured to hold a volume of a sample under test (SUT, e.g., blood or other biological fluid sample). For example, the microfluidic chamber includes an AJP-printed electrode (e.g., printed at 608) arranged so the bioactive ink is exposed to the SUT within the microfluidic chamber. Because at least one surface of the chamber is functionalized with the bioactive agent via AJP at 608, the functionalized surface(s) can interact with a biological fluid, as an SUT, within the microfluidic chamber. The microfluidic chamber thus can define part of a sensing apparatus that is configured to hold a volume of the biological fluid, as an SUT, and the sensing apparatus can include electronics configured to perform DS (e.g., DC) on one or more SUTs (e.g., blood or other biological fluids) as described herein.

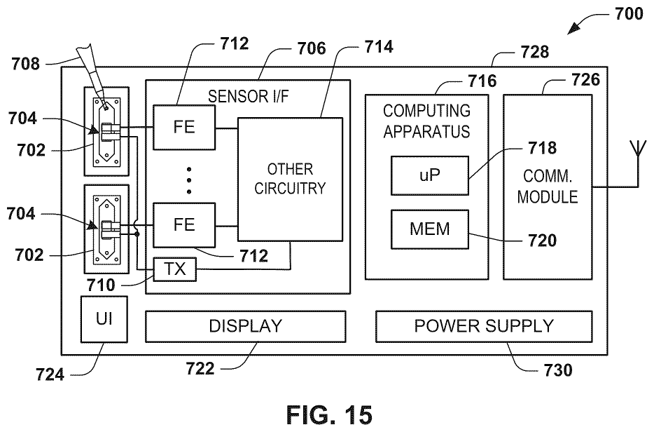

As a further example, FIG. 15 depicts an example of a dielectric spectroscopy (DS) microsystem (also referred to herein as a system) 700. The system 700 can be implemented as an integrated handheld system, which can utilize plug-and-play or other types of sensor structures. The components of the system 700 can be constructed of biocompatible materials, such as including gold, glass, and polymethyl methacrylate (PMMA), which are commonly used in biomicrofluidic devices. The DS system 700 can be configured to implement DC for blood SUTs.

The system 700 can include one or more sensing apparatuses (also referred herein to as sensors) 702, two of which are shown in the example of FIG. 15. Also, in the example of FIG. 15, each sensor 702 includes a capacitive sensing structure 704 having a number of electrodes, in which one or more bioactive agents have been AJP-printed on one or more of the electrodes. Each sensing apparatus (when the system includes two or more) can be functionalized with the same or different bioactive agents via AJP. The one or more sensors 702 can be formed as described with respect to the method 600 or as otherwise described herein. Each sensor 702 may be implemented as chips or other plug-and-play components (e.g., cartridges) adapted to be swapped into and out of the sensing system 700. In other examples, the one or more sensors 702 can be fixed in the system 700. For example, a user can select one or more sensor cartridges having one or more AJP-printed bioactive agents to interact with a given blood SUT, which agents enable a determination of a mechanism for analysis (e.g., DC, such as to determine a hemostatic dysfunction and/or other condition). An assortment of sensor cartridges having AJP-printed sensing structures 704 can be available with respective bioactive agents (e.g., a range of different procoagulants and/or anticoagulants) adapted to analyze blood samples for a range of different diseases and disorders. In other examples, the systems (e.g., system 10) and methods (e.g., method 600) described herein can be used to functionalize one or more sensing structures with one or more desired bioactive agents, which can be performed at a point of testing by aerosol jet printing with one or more bioactive agents according to testing needs. Various types of bioactive agents thus can be used in the one or more sensors 702 to analyze a range of biological fluids, such as described herein.

Associated sensor interface (I/F) electronics 706 are coupled to inputs and outputs of each sensor 702. Thus, the sensing structure 704 and interface electronics 706 can be configured to produce a complex output that depends on (e.g., varies as a mathematical function of) the complex dielectric permittivity of the SUT (e.g., blood or other biological fluid) disposed in the respective microfluidic channel of each sensor 702 in response to an excitation signal.

As an example, a micropipette (or other device, such as a syringe or the like) 708 can be employed to inject an SUT into the microfluidic channel of the sensor 702. The sensor interface electronics 706 includes transmitter (TX) circuitry 710 configured to provide the excitation signal (e.g., at single frequency or frequency range of one or more frequency bands) to an input of a given sensor containing a volume of the SUT. The output of each sensor 702 is coupled to respective front-end RF modules 712 (shown as FE) of a receiver. Each front-end RF module 712 is configured to preprocess (e.g., perform down-conversion, filtering, and amplification) each signal received in response to a transmitted excitation signal and provide corresponding output RF signals. The RF signals from a given one of the front-end RF module 712 can be selectively provided to other receiver circuitry 714 for further processing, such as including conversion to a digital version of the signal and being provided to computing apparatus 716, which includes one or more processors 718 and memory 720. The computing apparatus 716 can calculate permittivity for each SUT based on the system output signal to provide corresponding output permittivity values stored in memory 720 as permittivity data. The permittivity data for each sensor 702 can include real permittivity values or it may include complex permittivity values (e.g., real and imaginary permittivity values) computed over the range of excitation frequencies, including different sub-ranges provided to each sensor 702. Permittivity data can also include raw signal measurements and the input excitation frequencies. The computing apparatus 716 can also analyze the permittivity data to determine permittivity parameters of the SUT, including a comparison and/or correlation of permittivity data for each of the sensors 702 such as disclosed herein. The computing apparatus 716 can provide an indication of properties of the blood or other SUT based on the analysis of permittivity parameters for each SUT. One or more readout parameters describing permittivity parameters and/or hemostatic properties of the SUT (e.g., hemostatic dysfunction and associated coagulopathy) may be rendered on a display 722. The system 700 may include a user interface (UI) 724 that provides a human-machine interface to enable user interaction with the system 700, such as to configure parameters of the system 700, review results, send results to a remote station, acknowledge instructions, reset the system, or perform other human-machine interactions.

The computing apparatus 716 can further provide the permittivity data and analysis thereof to a communication module 726. The communication module 726 can send the output data and raw measurement data to a remote system. For example, the communication module 726 can transmit the output data to a back-office system or other remote system (e.g., a server or computing cloud) that can be programmed to analyze the data and store the results and raw data in a database. The remote system can also communicate command information to the system 700 to program one or more of the system parameters (e.g., signal gain and/or frequency range) to control its operation and/or provide instructions to the user, such as disclosed herein.

The system 700 in the example of FIG. 15 can include a housing, schematically shown at 728, that contains the sensor interface electronics 706, computing apparatus 716, and communication module 726 such that it can provide an integrated portable, handheld device. The system 700 may also include an internal power supply 730, such as an internal battery and/or a power interface to connect to an external supply. In other examples, different parts of the system 700 can reside in housing 728 and other parts can be outside of the housing. For example, while the example system 700 of FIG. 15 is in the context of a handheld device, in other examples, the system 700 may be implemented as a benchtop system. In this example, the system 700 may be configured to measure dielectric permittivity for a number of the sensors 702, each having a respective AJP-coated sensing structure (e.g., one or more AJP-coated electrodes) for measuring properties of a respective SUT. Each sensor 702 can include or share corresponding interface to provide respective measurement data to the computing apparatus 716 for computing permittivity values for each of the respective SUTs. In this way, a laboratory or other provider can monitor a plurality of samples concurrently.

In view of the foregoing, one or more microsensors, each having respective aerosol jet-printed bioactive agents, such as disclosed herein, can be pre-configured to provide respective sensors that may be operatively coupled to the sensing apparatus to assess different respective hemostatic dysfunctions or other physiological properties. In an example, a selected sensor having a predetermined bioactive agent(s) may be placed in respective ones of a plurality of sensor-receiving slots in a sensing apparatus (e.g., as disclosed in the above incorporated U.S. Pat. Pub. No. 2022/0326170) to detect different respective cellular and non-cellular abnormalities in hemostasis in a given sample of blood that is placed into the sensor. In another example, multiple different sensors, each preconfigured with different aerosol-jet-printed bioactive agents, may be placed in respective ones of a plurality of sensor-receiving slots in the apparatus concurrently to detect different respective cellular and non-cellular abnormalities in hemostasis in a given sample of blood.

Moreover, the fully electronic technique of dielectric spectroscopy can enable the readout to be integrated into a small-size, portable, hand-held instrument, which is highly advantageous for a variety of use scenarios, such as at point-of-care in hospitals, clinics, medical offices as well as ambulances or other point-of-injury locations. Examples of such devices are shown in the above-incorporated U.S. Pat. Pub. No. 2022/0326170, each of which can be functionalized for a particular use case using aerosol jet printing to apply one or more respective bioactive agents. The resulting systems, devices and methods thus can be adapted to provide a quantitative measure of hemostatic dysfunction, associated coagulopathy, or other measures of properties of the fluid SUT based on analysis of the dielectric permittivity values. The systems, devices and methods further can be used to determine a therapy for a given patient based on the quantitative measure of hemostatic dysfunction and/or associated coagulopathy.

Further, as described herein, a novel aqueous-phase ink for AJP containing phospholipids and the transmembrane protein TF can be applied to the surface of a substrate according to systems and methods described herein. The AJP parameters can be optimized for deposition of inks containing bioactive agents with and without electrolytes. As described, AJP-coated electrodes with the TF ink activate the extrinsic coagulation pathway and reduce Tₚₑₐₖ in DC assays.

The foregoing also demonstrates that electrode activity can be controlled by ink concentration of bioactive agent. Also, or alternatively, electrode activity can be controlled by spatial distribution of AJP-printed ink, which can be implemented by applying the bioactive agent in ink according to a wide range of printable patterns. Also, or alternatively, the systems and methods can be implemented to coat a single electrode with multiple reagents in discrete regions with minimal overlap. Moreover, the systems and methods described herein can use spatial deposition control (e.g., via configuring process parameters) to establish reagent gradients.

Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, and the term “including” means including but not limited to and the term “based on” means based at least in part on.

What are disclosed herein are examples. It is, of course, not possible to describe every conceivable combination of components or methods, but one of ordinary skill in the art will recognize that many further combinations and permutations are possible. Accordingly, the disclosure is intended to embrace all such alterations, modifications, and variations that fall within the scope of this application, including the appended claims. All references, publications, and patents cited in the present application are herein incorporated by reference in their entirety.

What is claimed is:

1. A method, comprising:
providing a bioactive ink having a concentration of a bioactive agent adapted to interact with a biological fluid; and
aerosol jet printing a volume of the bioactive ink on a substrate.

2. The method of claim 1, wherein the substrate comprises an electrode of a sensing apparatus.

3. The method according to claim 1, further comprising forming a microfluidic chamber that includes the substrate arranged so the bioactive ink is exposed within the microfluidic chamber, in which the microfluidic chamber is adapted to hold a volume of the biological fluid, as a sample under test.

4. The method of claim 3, wherein the substrate includes at least one plate of a multi-plate capacitive sensing structure.

5. The method of claim 1, further comprising forming a chamber having at least one exposed surface therein, constituting the substrate, and arranged to expose the bioactive ink within the chamber and thereby functionalize the surface of the at least one electrode with the bioactive agent to interact with the biological fluid, as a sample under test (SUT), within the chamber.

6. The method of claim 5, wherein prior to aerosol jet printing the volume of the bioactive ink, the method comprises forming at least one electrode structure of an electrically conductive material that defines the substrate, and wherein the volume of the bioactive ink is aerosol jet printed over at least a portion of the at least one electrode structure.

7. A sensing apparatus produced according to the method of claim 6.

8. The method of claim 1, wherein the bioactive agent in the bioactive ink includes a concentration of thrombin receptor-activating peptide 6 (TRAP-6) or tissue factor (TF).

9. The method of claim 1, further comprising controlling at least one process parameter of the aerosol jet printing.

10. The method of claim 9, wherein aerosol jet printing the volume of the bioactive ink includes applying two or more bioactive inks on a surface of the substrate, in which each of the two or more bioactive inks includes a different bioactive agent.

11. The method of claim 10, wherein the controlling the at least one process parameter includes controlling a printed geometry for each of the bioactive inks to provide respective patterns on the substrate including the different bioactive agents to provide a single sensor with multiple biological effects.

12. The method of claim 9, wherein the controlling the at least one process parameter includes controlling a printed geometry for the bioactive ink on the substrate to control a dose of bioactive agent.

13. A method of making a sensing apparatus, comprising:
aerosol jet printing a volume of a bioactive ink on a surface of at least one electrode, the bioactive ink having a concentration of a bioactive agent adapted to interact with a biological fluid;
forming a chamber that includes the at least one electrode arranged to expose the bioactive ink within the chamber and thereby functionalize the surface of the at least one electrode with the bioactive agent to interact with the biological fluid, as a sample under test (SUT), within the chamber; and
electrically coupling the at least one electrode with sensing electronics.

14. The method of claim 13, further comprising controlling at least one process parameter of the aerosol jet printing to configure an amount or spatial distribution of the bioactive ink on the surface of the at least one electrode.

15. The method of claim 13, wherein the controlling the at least one process parameter includes controlling a printed geometry for the bioactive inks to provide a predetermined pattern of the bioactive ink on the surface of the at least one electrode.

16. An apparatus, comprising:
a dielectric microsensor comprising a microfluidic chamber that includes a capacitive sensing structure, a volume of one or more aerosol-jet-printed bioactive agents on at least one inner surface of the microfluidic chamber to functionalize the at least one inner surface to interact with a biological fluid, as a sample under test (SUT), within the microfluidic chamber;
a transmitter to provide an input radio-frequency (RF) signal to an RF input of the dielectric microsensor;
a receiver to receive an output RF signal from an RF output of the dielectric microsensor; and
a computing device configured to compute dielectric permittivity values for the SUT based on the output RF signal over a time interval, the dielectric permittivity values being representative of the one or more bioactive agents interacting with SUT over the time interval, the computing device further configured to provide a readout based on the dielectric permittivity values.

17. The apparatus of claim 16, in which the one or more bioactive agents are aerosol jet printed in a predetermined pattern on the at least one inner surface of the chamber.

18. The apparatus of claim 16, wherein the biological fluid comprises blood, and the computing device is further programmed to provide a readout representative of hemostatic dysfunction and/or associated coagulopathy for the blood sample based on the dielectric permittivity values.

19. The apparatus of claim 16, wherein the computing device is further programmed to determine a therapy based on the quantitative measure of coagulopathy and provide an output specifying the determined therapy.

20. The apparatus of claim 16, wherein the computing device is further programmed to:
determine a quantitative measure of hemostatic dysfunction and/or associated coagulopathy; and
provide a readout representative of the quantitative measure of hemostatic dysfunction and/or associated coagulopathy.
